(19) United States
(12) Patent Application Publication
(10) Pub. No.: US 2015/0101391 A1
(43) Pub. Date: Apr. 16, 2015

(54) WEAR LIMIT DETERMINING GAUGE

(71) Applicant: Komatsu Ltd., Tokyo (JP)

(72) Inventors: Naoaki Kita, Hirakata-shi (JP); Hitoshi Fujisaki, Kawasaki-shi (JP)

(21) Appl. No.: 14/354,138

(22) PCT Filed: Sep. 27, 2013
(86) PCT No.: PCT/JP2013/076404

§ 371 Date: Apr. 25, 2014

(51) Int. Cl. G01N 3/56

(52) U.S. Cl. CPC G01N 3/56
USPC 73/7

(57) ABSTRACT

The present wear limit determining gauge is a wear limit determining gauge to be used in determining whether or not a wear loss of a track-related component of a tracked vehicle exceeds a predetermined amount, and includes a main body formed in a plate shape, a contact surface and a wear limit determining part. The contact surface is located on an end of the main body, and makes contact with a reference surface serving as a reference in determining the wear loss of the component. The wear limit determining part is disposed on a worn side of the component while the contact surface is contacted to the reference surface, and includes first, second and third determining portions.

### CROSS REFERENCE TO RELATED APPLICATIONS

This application claims priority to PCT application PCT/JP2013/076404 filed on Sep. 27, 2013. The entire disclosure of PCT application PCT/JP2013/076404 is hereby incorporated herein by reference.

### TECHNICAL FIELD

The present invention relates to a wear limit determining gauge for determining whether or not the wear loss of each component composing a crawler belt of a tracked vehicle such as a bulldozer, a hydraulic excavator or so forth has reached a wear limit at which component replacement is required.

### BACKGROUND ART

A tracked vehicle such as a bulldozer, a hydraulic excavator or so forth is equipped with a drive unit that one or more endless crawler belts are wrapped thereabout.

When the drive unit travels while the one or more crawler belts make contact with the ground, components of each crawler belt repeatedly make contact with the ground and with each other. Hence, the wear loss of each component (e.g., bushing, shoe, link, etc.) is gradually increased with increase in duration of usage. Because of this, each component is replaced when the wear loss thereof exceeds a predetermined amount.

For example, Japan Laid-open Registered Utility Model Publication No. JP-U-S49-124060 (disclosed on Oct. 24, 1974) discloses a wear loss measuring instrument for determining whether or not the wear loss of a track-related component of a tracked vehicle exceeds a predetermined amount.

This wear loss measuring instrument is a vernier caliper measuring instrument, and the length of each component is measured by reading a scale on the measuring instrument, while the measuring instrument is contacted to a measurement target portion of each component. Further, the wear degree of each component can be determined by comparing the measured length of each component with the length datum of each component in an unused condition.

### SUMMARY

However, the wear loss measuring instrument disclosed in the aforementioned publication has the following drawback.

Specifically, it is not easy to understand how to use the wear loss measuring instrument disclosed in the aforementioned publication. Therefore, anyone cannot necessarily perform measurement easily with use of the wear loss measuring instrument. Further, it is required to prepare the dimension datum of each component in an unused condition in order to determine whether or not the wear loss of each component exceeds a predetermined amount by means of the wear loss measuring instrument. Thus, a drawback is produced that the wear loss measuring instrument is inconvenient in measuring many kinds of measurement targets.

Incidentally, an ultrasonic wear loss meter has been also used. However, the wear loss meter has a drawback that great effort is required in measurement. For example, it is required to perform measurement after a measurement target is sufficiently cleaned and coupling liquid such as gel is then applied to the surface of the cleaned measurement target. Moreover, a drawback is produced that accuracy in a measurement result is degraded unless materials (e.g., earth and sand) attached to a measurement target are sufficiently removed.

It is an object of the present invention to provide a wear limit determining gauge that enables quick determination of whether or not a wear loss exceeds a predetermined amount with a simple structure.

(Solution to Problems)

A wear limit determining gauge according to a first embodiment of the invention is a wear limit determining gauge to be used in determining whether or not a wear loss of a track-related component of a tracked vehicle exceeds a predetermined amount, and includes a main body formed in a plate shape, a contact surface and a wear limit determining part. The contact surface is located on an end of the main body and makes contact with a reference surface serving as a reference in determining the wear loss of the component. The wear limit determining part is disposed on a worn side of the component while the contact surface is contacted to the reference surface, and respectively includes first, second and third determining portions. The first determining portion indicates that the wear loss is close to the predetermined amount. The second determining portion is disposed adjacently to the first determining portion through a step, and indicates that the wear loss approximates to the predetermined amount. The third determining portion is disposed adjacently to the second determining portion through a step, and indicates that the wear loss has reached the predetermined amount.

The wear limit determining gauge, which is used for appropriately managing the wear-attributed replacement timing of the track-related component of the tracked vehicle, herein includes the contact surface to be contacted to the reference surface on the worn component side and the first to third determining portions set in three stages. Further, the first to third determining portions are set in a stepwise manner so as to respectively indicate that the wear loss is close to the predetermined amount, that the wear loss approximates to the predetermined amount, and that the wear loss has reached the predetermined amount.

Where the wear loss (predetermined amount) at which component replacement is required is herein set to be 100%, for instance, the first to third determining portions set in three stages may be set correspondingly to 50%, 80% and 100% respectively.

Accordingly, in determining the wear loss of a worn component, it is possible to easily determine to which one of the first to third determining portions the present wear loss corresponds, only by firstly contacting the contact surface to the reference surface on the component side, and then under the condition, by approaching the wear limit determining part (first to third determining portions) to the worn portion of the component. As a result, only by contacting the wear limit determining gauge to the reference surface on the worn component side and the worn portion of the component, a user can quickly determine whether or not the component is in a condition of requiring replacement due to wear.

Further, in comparison with a well-known vernier caliper measuring instrument, a user is only required to contact the wear limit determining gauge to the worn component, and is not required to perform a measuring work. Therefore, determination of the worn component can be performed with a simple structure.

A wear limit determining gauge according to a second embodiment of the invention relates to the wear limit determining gauge according to the first invention, and wherein the contact surface and the wear limit determining part are grouped in a plurality of pairs so as to determine wear limits of measurement target portions having different sizes.

The plurality of pairs of the contact surface and the wear limit determining part are herein provided for determining the worn states of a plurality of components with use of the single wear limit determining gauge.

Accordingly, for instance, the plate-shaped main body can be provided with wear limit determining parts (first to third determining portions) on first, second and third ends thereof, while the wear loss limits of first, second and third components are respectively set to the wear limit determining parts in accordance with the types of measurement target components.

As a result, it is possible to perform determination of the plurality of worn components with use of the single wear limit determining gauge. Hence, usability of a user can be enhanced with a simple structure in comparison with a configuration of preparing different gauges in accordance with the types of components.

A wear limit determining gauge according to a third embodiment of the invention relates to the wear limit determining gauge according to the first or second invention, and wherein the plurality of pairs of the contact surface and the wear limit determining part are disposed on different lateral surfaces of the main body.

The aforementioned plurality of pairs of the contact surface and the wear limit determining part are herein respectively disposed on, for instance, different lateral surfaces of the main body formed in a polygonal shape.

Accordingly, in determining the wear states of different worn components, a user can easily perform determination in the same manner only by changing the lateral surface to be used for measurement. Further, the wear limit determining gauge can be formed with a compact size in comparison with a structure that pairs of the contact surface and the wear limit determining part are disposed on the same lateral surface in order to determine the wear states of different worn components.

A wear limit determining gauge according to a fourth embodiment of the invention relates to the wear limit determining gauge according to the first or second invention, and wherein the contact surface is provided as a common contact surface corresponding to the plurality of wear limit determining parts.

The contact surface to be contacted to the reference surface on the worn component side is herein commonly used among the plurality of wear limit determining parts.

Thus, with common use of the contact surface to be contacted to the reference surface on the worn component side, a user can measure a different worn component only by inverting the gauge direction and by measuring the worn component with use of another wear limit determining part. Further, with common use of the contact surface, the number of contact surfaces can be reduced, and thus, the wear limit determining gauge can be more simply structured.

A wear limit determining gauge according to a fifth embodiment of the invention relates to the wear limit determining gauge according to any one of the first to fourth embodiment of the inventions, and wherein the track-related component includes a crawler link, a crawler bushing and a crawler shoe that compose a drive unit of the tracked vehicle.

The crawler link, the crawler bushing and the crawler shoe, disposed in the periphery of a crawler belt of the drive unit of the tracked vehicle, are herein used as worn components for which wear limits are determined.

Accordingly, with use of the wear limit determining gauge, it is possible to appropriately manage the component replacement timings of the respective components that are most likely to be worn as the track-related components of the tracked vehicle.

A wear limit determining gauge according to a sixth embodiment of the invention relates to the wear limit determining gauge according to the fifth embodiment of the invention, and wherein the wear limit determining part includes a first, a second and a third wear limit determining parts. The second and third wear limit determining parts respectively determine the wear limits of the crawler bushing and the crawler shoe and are disposed on opposite lateral surfaces of the main body. A first wear limit determining part determines the wear limit of the crawler link and is disposed on a side of the main body part that is different from a side on which the second and third wear limit determining parts are disposed.

In the wear limit determining gauge for determining the wear losses of the aforementioned three components (i.e., the crawler link, the crawler bushing and the crawler shoe), the first wear limit determining part for measuring the crawler link having the largest measuring range is herein disposed on the first end side of the main body, whereas the second and third wear limit determining parts for respectively measuring the other components (i.e., the crawler bushing and the crawler shoe) are disposed on the second end side of the main body that is located on the opposite side of the first end side. Further, the second and third wear limit determining parts are respectively disposed on the opposite lateral surfaces of the main body.

Thus, the wear limit determining gauge can be more simply structured by efficiently disposing the first wear limit determining part targeting at the crawler link having the largest measuring range and the second and third wear limit determining parts targeting at the other components (i.e., the crawler bushing and the crawler shoe) on the lateral surfaces of the main body.

A wear limit determining gauge according to a seventh embodiment of the invention relates to the wear limit determining gauge according to the sixth embodiment of the invention, and wherein the second wear limit determining part and the third wear limit determining part are disposed on the same lateral surface of the main body part and respectively perform determination with use of the contact surface to be commonly used.

The aforementioned second wear limit determining part targeting at the crawler bushing and the aforementioned first wear limit determining part targeting at the crawler link are herein disposed on the same lateral surface side of the main body, and respectively perform determination with use of the common contact surface.

Accordingly, with common use of the contact surface between the second wear limit determining part targeting at the crawler bushing and the first wear limit determining part targeting at the crawler link, the number of contact surfaces can be reduced, and thereby, the wear limit determining gauge can be more simply structured.

A wear limit determining gauge according to an eighth invention is a wear limit determining gauge to be used in determining whether or not a wear loss of each of track-related components of a tracked vehicle exceeds a predetermined amount, and includes a main body formed in a plate shape, first to third contact surfaces and first to third wear limit determining parts. The first contact surface is located on an end of the main body, and makes contact with a reference surface serving as a reference in determining the wear loss of a first component. The first wear limit determining part is disposed on a worn side of the first component while the first contact surface is contacted to the reference surface, and includes: a first determining portion indicating that the wear loss is close to the predetermined amount; a second determining portion disposed adjacently to the first determining portion through a step and indicating that the wear loss approximates to the predetermined amount; and a third determining portion disposed adjacently to the second determining portion through a step and indicating that the wear loss has reached the predetermined amount. The second contact surface is located on an end of the main body that is different from the end on which the first contact surface is located, and makes contact with a reference surface serving as a reference in determining the wear loss of a second component. The second wear limit determining part is disposed on a worn side of the second component while the second contact surface is contacted to the reference surface, and includes: a first determining portion indicating that the wear loss is close to the predetermined amount; a second determining portion disposed adjacently to the first determining portion through a step and indicating that the wear loss approximates to the predetermined amount; and a third determining portion disposed adjacently to the second determining portion through a step and indicating that the wear loss has reached the predetermined amount. The third contact surface is located on an end of the main body that is different from the ends on which the first and second contact surfaces are disposed, and makes contact with a reference surface serving as a reference in determining the wear loss of a third component. The third wear limit determining part is disposed on a worn side of the third component while the third contact surface is contacted to the reference surface, and includes: a first determining portion indicating that the wear loss is close to the predetermined amount; a second determining portion disposed adjacently to the first determining portion through a step and indicating that the wear loss approximates to the predetermined amount; and a third determining portion disposed adjacently to the second determining portion through a step and indicating that the wear loss has reached the predetermined amount.

The wear limit determining gauge, which is used for appropriately managing the wear-attributed replacement timings of the track-related components of the tracked vehicle, herein includes the first to third contact surfaces to be contacted to the reference surface on the worn component side and the first to third wear limit determining parts, each of which includes the first to third determining portions set in three stages. Further, the first to third determining portions are set in a stepwise manner so as to respectively indicate that the wear loss is close to the predetermined amount, that the wear loss approximates to the predetermined amount, and that the wear loss has reached the predetermined amount. Further, a plurality of pairs of the contact surface and the wear limit determining part are provided for determining the wear states of the plurality of components with use of the single wear limit determining gauge.

Where the wear loss (predetermined amount) at which component replacement is required is herein set to be 100%, for instance, the first to third determining portions set in three stages may be set correspondingly to 50%, 80% and 100% respectively.

Accordingly, in determining the wear loss of a worn component, it is possible to easily determine to which one of the first to third determining portions the present wear loss corresponds, only by firstly contacting the contact surface to the reference surface on the component side, and then under the condition, by sliding the wear limit determining part (first to third determining portions) to the worn portion of the component. As a result, only by contacting the wear limit determining gauge to the reference surface on the worn component side and the worn portion of the component, a user can quickly determine whether or not the component is in a condition of requiring replacement due to wear.

Further, in comparison with a well-known vernier caliper measuring instrument, a user is only required to contact the wear limit determining gauge to the worn component, and is not required to perform a measuring work. Therefore, determination of the worn component can be performed with a simple structure.

Further, for instance, the plate-shaped main body can be provided with the first to third wear limit determining parts on first, second and third ends thereof; while the wear loss limits of first, second and third components are respectively set to the first to third wear limit determining parts in accordance with the types of measurement target components.

As a result, it is possible to perform determination of the plurality of worn components with use of the single wear limit determining gauge. Hence, usability of a user can be enhanced with a simple structure in comparison with a configuration of preparing different gauges in accordance with the types of components.

(Effects)

According to the wear limit determining gauge of the present invention, it is possible to quickly determine whether or not the wear loss of a worn component exceeds a predetermined amount with a simple structure.

### BRIEF DESCRIPTION OF THE DRAWINGS

FIG. 1 is an entire perspective view of a structure of a bulldozer for which the wear loss is measured by means of a wear limit determining gauge of the present exemplary embodiment.

FIG. 2 is a side view of a structure of a drive unit of the bulldozer in FIG. 1.

FIG. 3 is an entire perspective view of a structure of the wear limit determining gauge for determining the wear limit with respect to a wear measurement target portion of the drive unit in FIG 2.

FIG. 4 is a diagram illustrating a condition in determining the wear loss of a link height with use of the wear limit determining gauge in FIG. 3.

FIG. 5 is a diagram illustrating a condition in determining the wear loss of a bushing with use of the wear limit determining gauge in FIG. 3.

FIG. 6 is a diagram illustrating a condition in determining the wear loss of a grouser height with use of the wear limit determining gauge in FIG. 3.

FIG. 7 is a perspective view of a structure of a wear limit determining gauge according to another exemplary embodiment of the present invention.

### DETAILED DESCRIPTION

Using drawings, explanation will be made for a wear limit determining gauge 10 according to an exemplary embodiment of the present invention as follows.

It should be noted that the present exemplary embodiment will be explained by exemplifying a bulldozer (tracked vehicle) 1 as a tracked vehicle for which the wear limit is determined with use of the wear limit determining gauge 10.

(Entire Structure of Bulldozer 1)

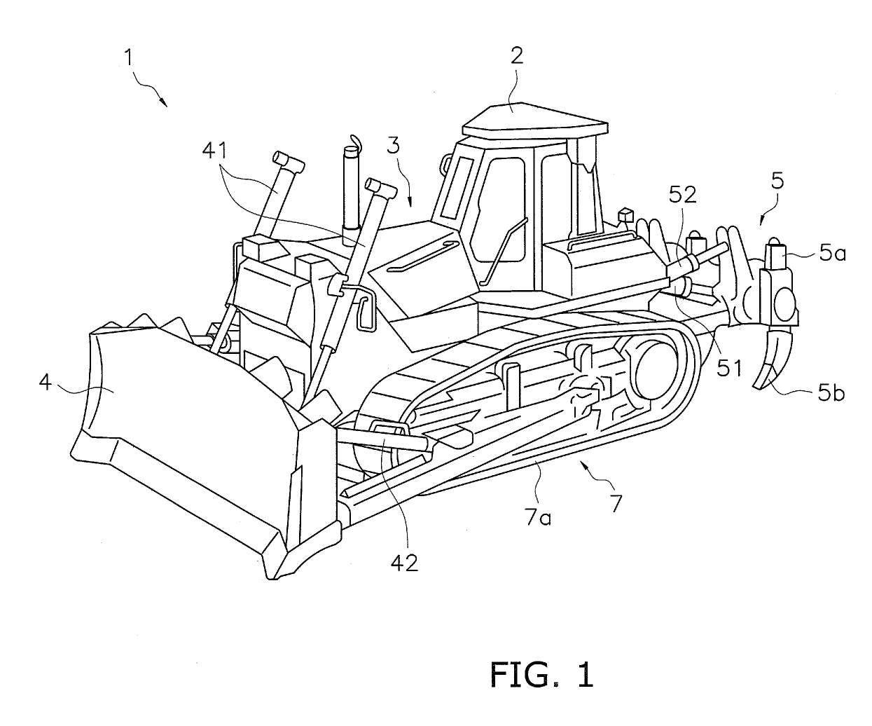

The bulldozer 1 according to the present exemplary embodiment is a tracked vehicle for performing a leveling work on the unleveled ground, and as illustrated in FIG. 1, mainly includes a cab 2, a vehicle body frame 3, a blade 4, a ripper unit 5 and a drive unit 7.

An operator seat (driver seat) on which a driver (operator) is seated, levers for performing various operations, pedals, meters and so forth are embedded in the inside of the cab 2.

Work implements, such as the blade 4, the ripper unit 5 and so forth, and the drive unit 7 are attached to the vehicle body frame 3, and the cab 2 is mounted to the upper part of the vehicle body frame 3.

The blade 4 is disposed forward of the vehicle body frame 3. The blade 4 is a work implement for digging the ground and carrying the dug earth and sand while pushing them. The blade 4 is configured to be driven by hydraulic cylinders (blade lift cylinders 41, blade tilt cylinders 42) in response to an operation of a blade operating lever disposed within the cab 2.

The ripper unit 5 is disposed rearward of the vehicle body frame 3. The ripper unit 5 is configured to stick a ripper tip 5b, attached to the tip end of a shank 5b protruded roughly vertically downward, into a rock or so forth, and cut and crash the rock or so forth by means of traction force of the drive unit 7. Further, similarly to the blade 4, the ripper unit 5 is configured to be driven by hydraulic cylinders (ripper lift cylinders 51, ripper tilt cylinders 52) in response to an operation of a ripper operation lever disposed within the cab 2.

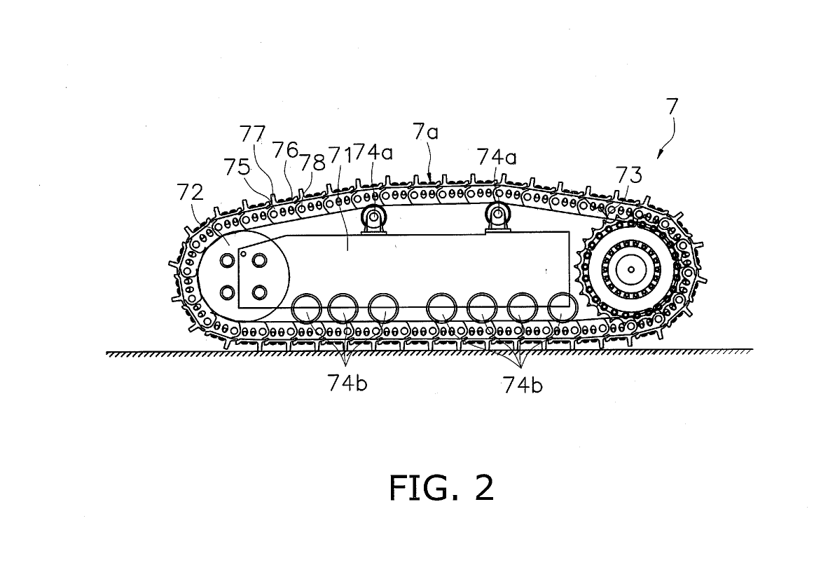

As illustrated in FIG. 1, the drive unit 7 causes the bulldozer 1 to travel by circulating crawler belts 7a while supporting the vehicle body frame 3 from bottom. More specifically, as illustrated in FIG. 2, the drive unit 7 includes: the crawler belts 7a; track frames 71 disposed and mounted along the vehicle back-and-forth direction; idler tumblers 72 and sprocket wheels 73 as travelling wheels; and carrier and track rollers 74a and 74b; and so forth. Further, the drive unit 7 enables travelling on the unleveled ground by circulating a pair of the endless crawler belts 7a respectively disposed on the right and left lower parts of the vehicle body frame 3 while the crawler belts 7a are supported by the idler tumblers 72, the sprocket wheels 63, the carrier and track rollers 74a and 74b and so forth from the inner peripheral surface side thereof.

It should be noted that in the following paragraphs, detailed description will be made for portions, which are included in the drive unit 7 and for which wear limit is determined

(Wear Limit Determined Portions of Drive Unit 7)

As described above, the drive unit 7 of the present exemplary embodiment causes the bulldozer 1 to travel by circulating the endless crawler belts 7a in engagement with the ground.

Here, among a large number of components composing each crawler belt 7a, some components are gradually worn by the contact with the ground and the other components during travelling of the bulldozer 1. Explanation will be herein made by exemplifying a crawler link 75, a crawler shoe 76 and a crawler bushing 79 as components for which wear determination is performed with use of the wear limit determining gauge 10 to be described.

As illustrated in FIG. 2, each crawler belt 7a is made in the form of an endless belt by coupling the plural crawler shoes 76 through the crawler links 75 and coupling pins 78.

Each crawler shoe 76 has a width directional protruded portion (grouser 77) protruded to the front side on the long-side region of the flat part of the ground engaging surface thereof, and is fixed to each crawler link 75 on the inner peripheral surface of each crawler belt 7a. Therefore, a part of the grouser 77, being engaged with the ground during travelling of the bulldozer 1, is gradually worn in each crawler shoe 76. In general, the grouser 77 is integrally formed with the crawler shoe 76.

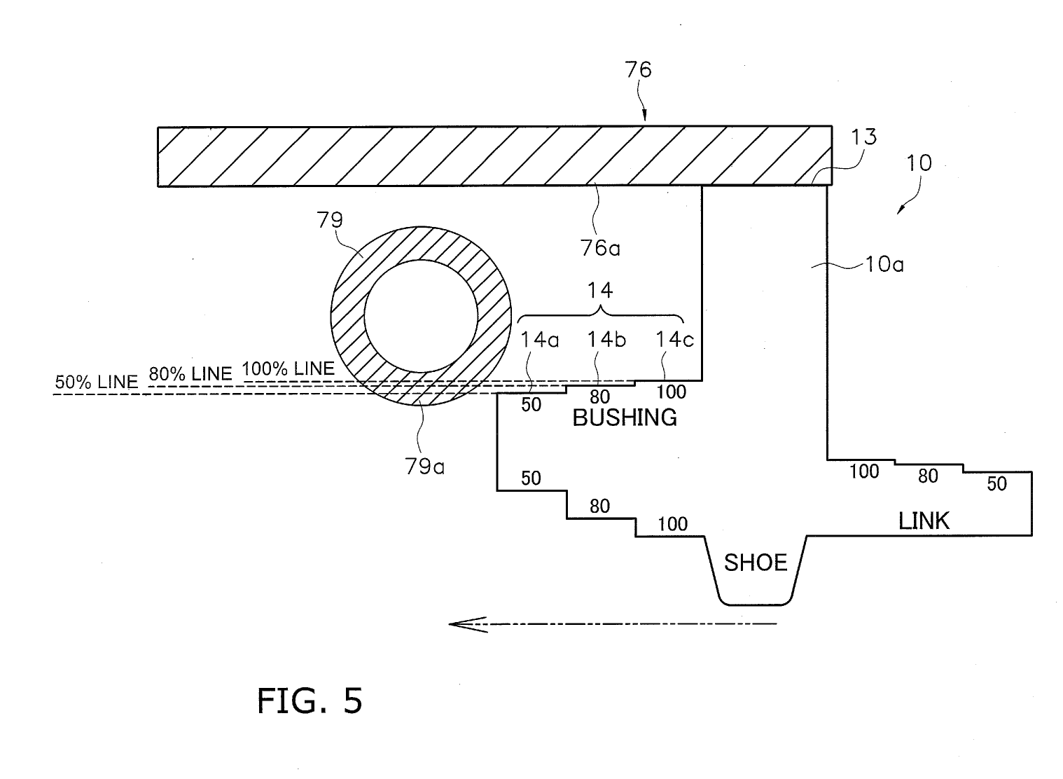

Each crawler link 75 has a bushing hole (not illustrated in the drawings) that penetrates width-directionally through the end portion thereof located on the opposite side of the side that the coupling pin 78 is inserted, and the crawler bushing 79 (see FIG. 5) is inserted into the bushing hole. With the structure, each crawler belt 7a can be circulated by means of rotational driving force applied thereto while the outer peripheral surface of each crawler bushing 79 is meshed with the sprocket 73. A surface of each crawler link 75, formed on the opposite side of the side that the crawler shoe 76 is fixed, is referred to as a tread face 75a. During travelling of the bulldozer 1, the idler tumbler 72 and the track rollers 74a and 74b roll on the surface of the tread face 75a. Therefore, during travelling of the bulldozer 1, the tread face 75a of each crawler link 75 is gradually worn by the contact with the track rollers and so forth. Further, each crawler bushing 79 is also gradually worn by the contact with the sprocket wheel 73 and so forth.

(Wear Limit Determining Gauge 10)

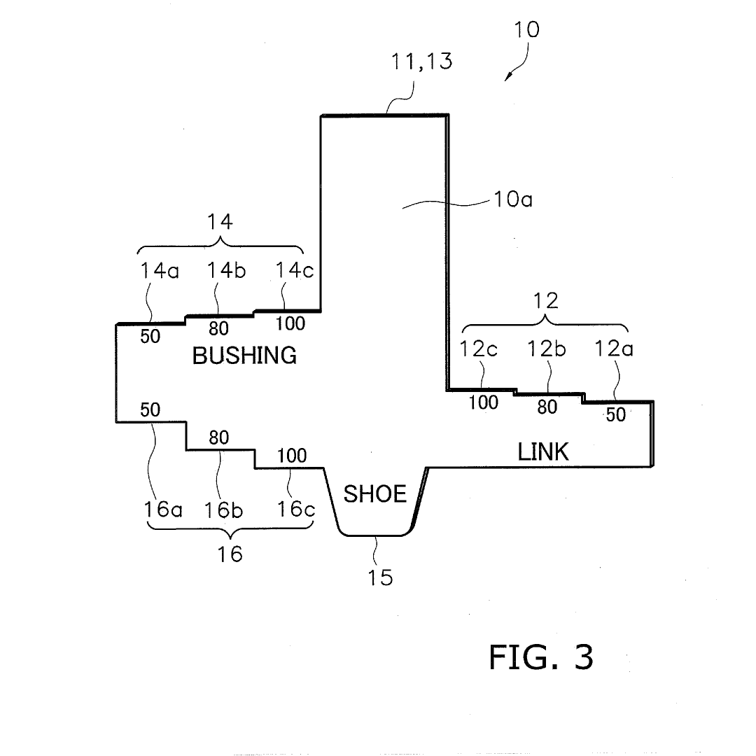

The wear limit determining gauge 10 of the present exemplary embodiment is a thin plate-shaped instrument to be used for appropriately managing the replacement timing of a worn component of a track-type drive unit, and is capable of determining the wear losses of three types of components (the crawler link 75, the crawler bushing 79 and the crawler shoe 76). Further, as illustrated in FIG. 3, the wear limit determining gauge 10 has a main body 10a, a link contact surface (contact surface, first contact surface) 11, a link determining part (wear limit determining part, first wear limit determining part) 12, a bushing contact surface (contact surface, second contact surface) 13, a bushing determining part (wear limit determining part, second wear limit determining part) 14, a shoe contact surface (contact surface, third contact surface) 15 and a shoe determining part (wear limit determining part, third wear limit determining part) 16.

The main body 10a is a flat plate-shaped member with a thickness of several mm and is produced by shaping a gauge steel plate, a stainless steel plate or so forth. The respective contact surfaces 11, 13 and 15 and the respective determining parts 12, 14 and 16 are formed on portions of the lateral surface of the main body 10a.

(Link Measurement Target Portion)

In the wear limit determining gauge 10 of the present exemplary embodiment, the wear loss of each crawler link 75 is determined with use of the link contact surface 11 and the link determining part 12.

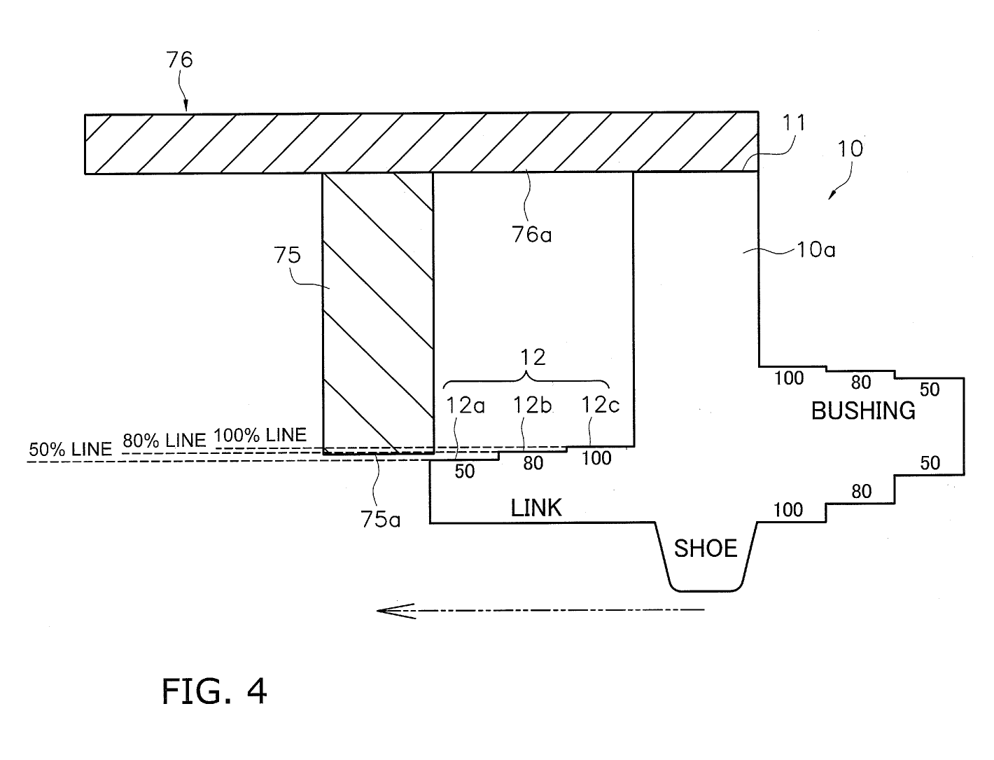

The link contact surface 11 is disposed on the upper end surface of the main body 10a in FIG. 3, and is contacted to the inner face (reference surface) 76a of each crawler shoe 76 in determining the wear loss of each crawler link 75 (see FIG. 4).

As illustrated in FIG. 3, the link determining part 12 has a 50% determining portion (first determining portion) 12a, an 80% determining portion (second determining portion) 12b and a 100% determining portion (third determining portion) 12c, which are sequentially formed on the lateral surface of the main body 10a from the gauge end towards the main body 10a while being located on the same side as the link contact surface 11. Further, as illustrated in FIG. 4, the link determining part 12 is disposed on the same side as the worn tread face 75a of each crawler link 75 while the link contact surface 11 is contacted to the inner face 76a of each crawler shoe 76. Accordingly, only by gradually sliding the wear limit determining gauge 10 while the link contact surface 11 is contacted to the inner face 76a of each crawler shoe 76, it is possible to easily determine to which stage the link height of the worn crawler link 75 is closest among three stages for indicating wear progression degrees in the link determining part 12.

The 50% determining portion 12a is set as a caution stage for indicating that the crawler link 75 is close to the component replacement timing, and means that the crawler link 75 has been worn at 50% where a predetermined amount of wear loss, corresponding to component replacement, is set to be 100%.

The 80% determining portion 12b is set as a warning stage for indicating that the crawler link 75 is on the verge of the component replacement timing, and means that the crawler link 75 has been worn at 80% where a predetermined amount of wear loss, corresponding to component replacement, is set to be 100%.

The 100% determining portion 12c is set as a final stage for indicating that the crawler link 75 has reached the component replacement timing, and means that the crawler link 75 has been worn at 100% where a predetermined amount of wear loss, corresponding to component replacement, is set to be 100%. In short, when the worn portion of the crawler link 75 has been worn to a height corresponding to the 100% determining portion 12c while the link contact surface 11 is contacted to the inner face 76a of each crawler shoe 76, this means that component replacement is required immediately.

Thus, with use of the wear limit determining gauge 10, a user, who inspects wear of each crawler link 75, can easily recognize a period of time remaining till the component replacement timing at a glance.

It should be noted that as illustrated in FIG. 3, the link determining part 12 is disposed on the opposite side (right side in the drawing) of the side (left side in the drawing) that the other bushing determining part 14 and shoe determining part 16 are disposed.

Such arrangement is set in consideration of that the length of the measurement target portion of the crawler link 75 is greater than that of each of the other crawler bushing 79 and crawler shoe 76 (grouser 77).

Accordingly, even when a plurality of determining parts are provided for performing wear inspections of a plurality of components, the wear limit determining gauge 10 can be formed as compactly as possible by effectively disposing the respective determining parts.

(Bushing Measurement Target Portion)

In the wear limit determining gauge 10 of the present exemplary embodiment, the wear loss of each crawler bushing 79 is determined with use of the bushing contact surface 13 and the bushing determining part 14.

The bushing contact surface 13 is disposed on the upper end surface of the main body 10a in FIG. 3, and is contacted to the inner face (reference surface) 76a of each crawler shoe 76 in determining the wear loss of each crawler bushing 79 (see FIG. 5). In other words, the bushing contact surface 13 is the same lateral surface as the link contact surface 11. In determining the wear loss of each crawler link 75 and that of each crawler bushing 79, the common surface is set as the contact surfaces for these components.

As illustrated in FIG. 3, the bushing determining part 14 has a 50% determining portion (first determining portion) 14a, an 80% determining portion (second determining portion) 14b and a 100% determining portion (third determining portion) 14c, which are sequentially formed on the lateral surface of the main body 10a from the gauge end towards the main body 10a while being located on the same side as the bushing contact surface 13. Further, as illustrated in FIG. 5, the bushing determining part 14 is disposed on the same side as a worn portion 79a of the crawler bushing 79, while the bushing contact surface 13 is contacted to the inner face 76a of each crawler shoe 76. Accordingly, only by gradually sliding the wear limit determining gauge 10 while the bushing contact surface 13 is contacted to the inner face 76a of each crawler shoe 76, it is possible to easily determine to which stage the worn crawler bushing 79 is closest among three stages for indicating wear progression degrees in the bushing determining part 14.

The 50% determining portion 14a is set as a caution stage for indicating that the crawler bushing 79 is close to the component replacement timing, and means that the crawler bushing 79 has been worn at 50% where a predetermined amount of wear loss, corresponding to component replacement, is set to be 100%.

The 80% determining portion 14b is set as a warning stage for indicating that the crawler bushing 79 is on the verge of the component replacement timing, and means that the crawler bushing 79 has been worn at 80% where a predetermined amount of wear loss, corresponding to component replacement, is set to be 100%.

The 100% determining portion 14c is set as a final stage for indicating that the crawler bushing 79 has reached the component replacement timing, and means that the crawler bushing 79 has been worn at 100% where a predetermined amount of wear loss, corresponding to component replacement, is set to be 100%. In short, when the worn portion of the crawler bushing 79 has been worn to a height corresponding to the 100% determining portion 14c while the bushing contact surface 13 is contacted to the inner face 76a of each crawler shoe 76, this means that component replacement is required immediately.

Thus, with use of the wear limit determining gauge 10, a user, who inspects wear of each crawler bushing 79, can easily recognize a period of time remaining till the component replacement timing at a glance

It should be noted that the respective steps on the bushing determining part 14 are formed so as to be smaller than those on the link determining part 12. This is because the acceptable wear loss (a predetermined wear loss limit that at which component replacement is required) of each crawler bushing 79 is less than that of each crawler link 75.

Further, as illustrated in FIG. 3, the bushing determining part 14 is formed on the lateral surface of the main body 10a, while being located on the opposite side of the shoe determining part 16. Such arrangement is set as a result of arranging the respective determining parts within the main body 10a as efficiently as possible, because the size required for performing a wear inspection of the aforementioned crawler link 75 is greater than that of the crawler bushing 79 and that of the crawler shoe 76.

(Shoe (Grouser) Measurement Target Portion)

In the wear limit determining gauge 10 of the present exemplary embodiment, the wear loss of the height of the grouser 77 of each crawler shoe 76 is determined with use of the shoe contact surface 15 and the shoe determining part 16.

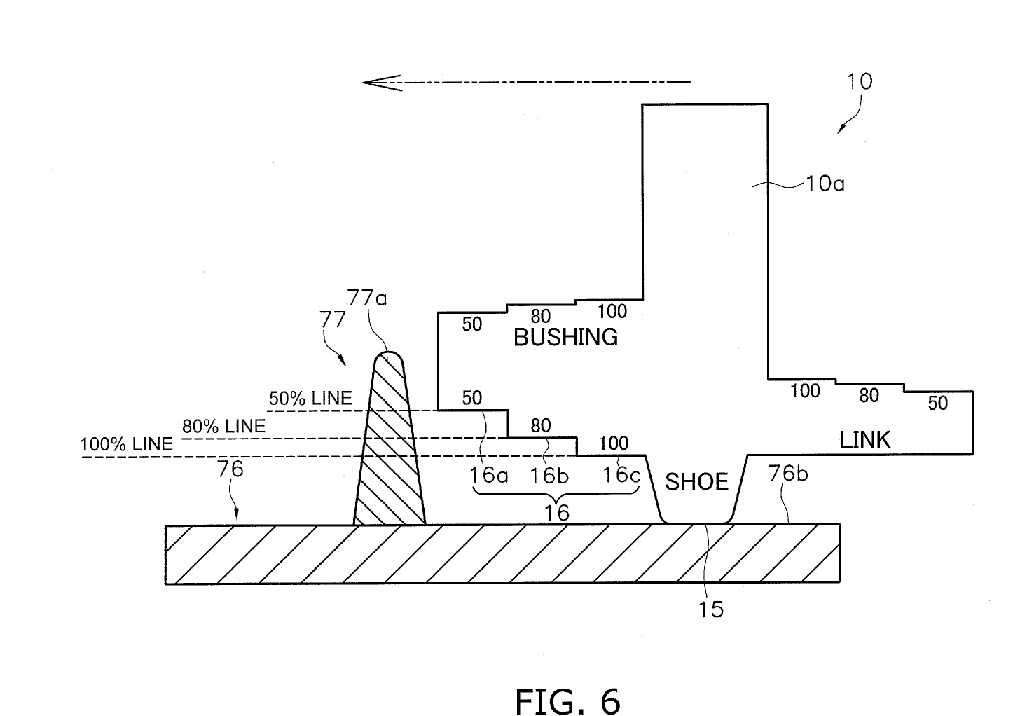

The shoe contact surface 15 is disposed on the lower end surface of the main body 10a in FIG. 3, and is contacted to an outer face (reference surface) 76b of each crawler shoe 76 in determining the wear loss of the grouser 77 disposed on the outer face 76b of each crawler shoe 76 (see FIG. 6). Further, the shoe contact surface 15 is formed on a lateral surface located on the opposite side of the lateral surface on which the link contact surface 11 (and the bushing contact surface 13) is formed.

As illustrated in FIG. 3, the shoe determining part 16 has a 50% determining portion (first determining portion) 16a, an 80% determining portion (second determining portion) 16b and a 100% determining portion (third determining portion) 16c, which are sequentially located on the lateral surface of the main body 10a from the gauge end towards the main body 10a while being located on the same side as the shoe contact surface 15. Further, as illustrated in FIG. 6, the shoe determining part 16 is disposed on the same side as a worn portion 77a of the grouser 77, while the shoe contact surface 15 is contacted to the outer face 76b of each crawler shoe 76. Accordingly, only by gradually sliding the wear limit determining gauge 10 while the shoe contact surface 15 is contacted to the outer face 76b of each crawler shoe 76, it is possible to easily determine to which stage the worn grouser 77 is closest among three stages for indicating wear progression degrees in the shoe determining part 16.

The 50% determining portion 16a is set as a caution stage for indicating that the crawler shoe 76 is close to the component replacement timing, and means that the crawler shoe 76 has been worn at 50% where a predetermined amount of wear loss, corresponding to component replacement, is set to be 100%.

The 80% determining portion 16b is set as a warning stage for indicating that the crawler shoe 76 is on the verge of the component replacement timing, and means that the crawler shoe 76 has been worn at 80% where a predetermined amount of wear loss, corresponding to component replacement, is set to be 100%.

The 100% determining portion 16c is set as a final stage for indicating that the crawler shoe 76 has reached the component replacement timing, and means that the crawler shoe 76 has been worn at 100% where a predetermined amount of wear loss, corresponding to component replacement, is set to be 100%. In short, when the worn portion 77a of the grouser 77 has been worn to a height corresponding to the 100% determining portion 16c while the shoe contact surface 15 is contacted to the outer face 76b of each crawler shoe 76, this means that component replacement is required immediately.

Thus, with use of the wear limit determining gauge 10, a user, who inspects wear of each crawler shoe 76 (grouser 77), can easily recognize a period of time remaining till the component replacement timing at a glance.

It should be noted that the respective steps on the shoe determining part 16 are formed so as to be larger than those on the other link determining part 12 and bushing determining part 14. This is because the acceptable wear loss (a predetermined wear loss limit at which component replacement is required) of each crawler shoe 76 (grouser 77) is greater than the acceptable wear losses of the other components.

<Method of Determining Wear Limit>

As described below, with the wear limit determining gauge 10 of the present exemplary embodiment, it is determined to which stage the crawler link 75, the crawler bushing 79 and the crawler shoe 76 (grouser 77) have been respectively worn among stages to the wear limit at which component replacement is required.

<About Crawler Link 75>

As illustrated in FIG. 4, in inspecting the wear loss of each crawler link 75, the link determining part 12 is gradually approached to the worn tread face 75a of the crawler link 75 by gradually sliding the link determining part 12 in an arrow direction depicted in FIG. 4 while the link contact surface 11 is contacted to the inner face 76a of each crawler shoe 76.

At this time, it is determined which one of the step portions of the link determining part 12 can be slid inward of the worn portion in accordance with the degree of the wear loss of the crawler link 75.

Specifically, when the 50% determining portion 12a cannot be slid inward of a part including the worn tread face 75a of the crawler link 75 by gradually sliding the wear limit determining gauge 10 in the arrow direction, it is possible to recognize that the present wear loss of the crawler link 75 is less than 50% with respect to the wear loss limit Therefore, a user can easily recognize that there is still time left till the replacement timing of the crawler link 75.

On the other hand, when only the 50% determining portion 12a can be slid inward of the part including the worn tread face 75a of the crawler link 75 by gradually sliding the wear limit determining gauge 10 in the arrow direction, it is possible to recognize that the present wear loss of the crawler link 75 is greater than or equal to 50% and less than 80% with respect to the wear loss limit. Therefore, a user can easily recognize that the crawler link 75 is close to the replacement timing.

Yet on the other hand, when only the 80% determining portion 12b can be slid inward of the part including the worn tread face 75a of the crawler link 75 by gradually sliding the wear limit determining gauge 10 in the arrow direction, it is possible to recognize that the present wear loss of the crawler link 75 is greater than or equal to 80% and less than 100% with respect to the wear loss limit. Therefore, a user can easily recognize that the crawler link 75 is on the verge of the replacement timing

According to the wear limit determining gauge 10 of the present exemplary embodiment, with the aforementioned simple inspection, it is possible to easily determine to which stage the wear loss of the crawler link 75 has been progressed among the stages to the replacement timing.

<About Crawler Bushing 79>

As illustrated in FIG. 5, in inspecting the wear loss of each crawler bushing 79, the bushing determining part 14 is gradually approached to the worn portion 79a of the cylindrical crawler bushing 79 by gradually sliding the bushing determining part 14 in an arrow direction depicted in FIG. 5 while the bushing contact surface 13 is contacted to the inner face 76a of each crawler shoe 76.

At this time, it is determined which one of the step portions of the bushing determining part 14 can be slid inward of the worn portion in accordance with the degree of the wear loss of the crawler bushing 79.

Specifically, when the 50% determining portion 14a cannot be slid inward of a part including the worn portion 79a of the crawler bushing 79 by gradually sliding the wear limit determining gauge 10 in the arrow direction, it is possible to recognize that the present wear loss of the crawler bushing 79 is less than 50% with respect to the wear loss limit Therefore, a user can easily recognize that there is still time left till the replacement timing of the crawler bushing 79.

On the other hand, when only the 50% determining portion 14a can be slid inward of the part including the worn portion 79a of the crawler bushing 79 by gradually sliding the wear limit determining gauge 10 in the arrow direction, it is possible to recognize that the present wear loss of the crawler bushing 79 is greater than or equal to 50% and less than 80% with respect to the wear loss limit Therefore, a user can easily recognize that the crawler bushing 79 is close to the replacement timing.

Yet on the other hand, when only the 80% determining portion 14b can be slid inward of the part including the worn portion 79a of the crawler bushing 79 by gradually sliding the wear limit determining gauge 10 in the arrow direction, it is possible to recognize that the present wear loss of the crawler bushing 79 is greater than or equal to 80% and less than 100% with respect to the wear loss limit Therefore, a user can easily recognize that the crawler bushing 79 is on the verge of the replacement timing.

According to the wear limit determining gauge 10 of the present exemplary embodiment, with the aforementioned simple inspection, it is possible to easily determine to which stage the wear loss of the crawler bushing 79 has been progressed among the stages to the replacement timing

<About Crawler Shoe 76 (Grouser 77)>

As illustrated in FIG. 6, in inspecting the wear loss of each crawler shoe 76 (grouser 77), the shoe determining part 16 is gradually approached to the worn portion 77a of the grouser 77 by gradually sliding the shoe determining part 16 in an arrow direction depicted in FIG. 6 while the shoe contact surface 15 is contacted to the outer face 76b of each crawler shoe 76.

At this time, it is determined which one of the step portions of the shoe determining part 16 can be slid outward of the worn portion in accordance with the degree of the wear loss of the grouser 77.

Specifically, when the 50% determining portion 16a cannot be slid outward of a part including the worn portion 77a of the grouser 77 by gradually sliding the wear limit determining gauge 10 in the arrow direction, it is possible to recognize that the present wear loss of the grouser 77 is less than 50% with respect to the wear loss limit Therefore, a user can easily recognize that there is still time left till the replacement timing of the crawler shoe 76 (grouser 77).

On the other hand, when only the 50% determining portion 16a can be slid under (outward of) the worn portion 77a of the grouser 77 by gradually sliding the wear limit determining gauge 10 in the arrow direction, it is possible to recognize that the present wear loss of the grouser 77 is greater than or equal to 50% and less than 80% with respect to the wear loss limit Therefore, a user can easily recognize that the crawler shoe 76 (grouser 77) is close to the replacement timing

Yet on the other hand, when only the 80% determining portion 16b can be slid under (outward of) the worn portion 77a of the grouser 77 by gradually sliding the wear limit determining gauge 10 in the arrow direction, it is possible to recognize that the present wear loss of the grouser 77 is greater than or equal to 80% and less than 100% with respect to the wear loss limit Therefore, a user can easily recognize that the crawler shoe 76 (grouser 77) is on the verge of the replacement timing

According to the wear limit determining gauge 10 of the present exemplary embodiment, with the aforementioned simple inspection, it is possible to easily determine to which stage the wear loss of the crawler shoe 76 (grouser 77) has been progressed among the stages to the replacement timing

<<Main Features>>

The wear limit determining gauge 10 of the present exemplary embodiment is an instrument to be used for performing a wear inspection of a specific track-related component (the crawler link 75, the crawler bushing 79, the crawler shoe 76) of the bulldozer 1, and has the plate-shaped main body 10a, the contact surfaces 11, 13 and 15 corresponding to the respective components, and the determining parts 12, 14 and 16.

Each contact surface 11, 13, 15 is disposed on the end portion of the main body 10a, and is contacted to the reference surface (the inner face 76a or the outer face 76b of each crawler shoe 76) as the reference in determining the wear loss of each worn component.

Each determining part 12, 14, 16 is disposed on the worn side of each component while each contact surface 11, 13, 15 is contacted to the reference surface, and has 50%, 80% and 100% determining portions 12a/14a/16a, 12b/14b/16b and 12c/14c/16c. The 50% determining portion 12a, 14a, 16a indicates that the wear loss of each component is close to a predetermined amount. The 80% determining portion 12b, 14b, 16b is disposed adjacently to the 50% determining portion 12a, 14a, 16a through the step, and indicates that the wear loss approximates to the predetermined amount. The 100% determining portion 12c, 14c, 16c is disposed adjacently to the 80% determining portion 12b, 14b, 16b through the step, and indicates that the wear loss has reached the predetermined amount corresponding to component replacement.

Accordingly, a user can easily recognize to which stage each component has been worn among the stages to the wear loss limit that indicates the replacement timing of the worn component, only by checking to which step portion the worn-side portion of each component corresponds among the step portions of the determining part 12, 14, 16 corresponding to each component, while each contact surface 11, 13, 15 is contacted to the reference surface (the inner face 76a, the outer face 76b) of each component. Therefore, in comparison with a configuration of performing a wear inspection with use of a well-known vernier caliper measuring instrument, technique is not required for measurement and the degree of wear can be quickly recognized Thus, with a simple structure, anyone can easily perform a wear inspection of a target component.

Further, determination of a plurality of worn components can be performed with a single wear limit determining gauge by providing the single wear limit determining gauge 10 with portions for performing wear inspections of a plurality of components as with the present exemplary embodiment. As a result, usability of a user can be enhanced with a compact and simple structure in comparison with a configuration of preparing different gauges in accordance with the types of components.

### Other Exemplary Embodiments

An exemplary embodiment of the present invention has been explained above. However, the present invention is not limited to the aforementioned exemplary embodiment, and a variety of changes can be made without departing from the scope of the present invention.

(A)

The aforementioned exemplary embodiment has been explained by exemplifying the wear limit determining gauge 10 that can determine the wear losses of three components (the crawler link 75, the crawler bushing 79, the crawler shoe 76). However, the present invention is not limited to the above.

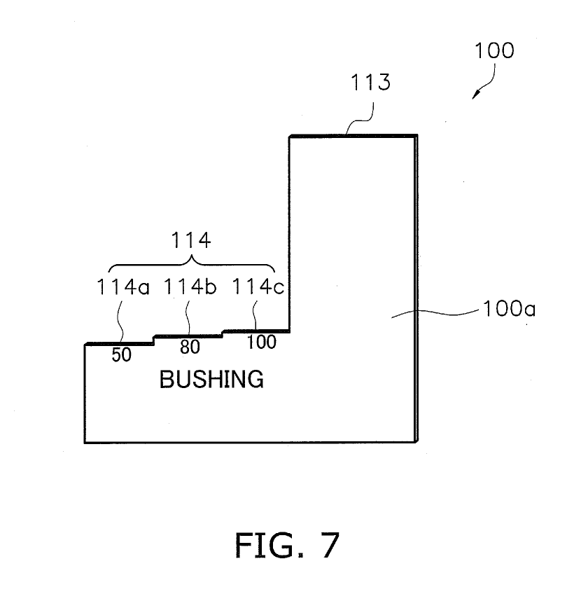

For example, as illustrated in FIG. 7, a wear limit determining gauge 100 may be employed that is configured to determine only the wear limit of the bushing.

As illustrated in FIG. 7, the wear limit determining gauge 100 of the present exemplary embodiment has a main body 100a formed in a thin plate shape, a contact surface 113 and a wear limit determining part 114.

Even in this example, similarly to the aforementioned exemplary embodiment, the component replacement timing can be easily determined with use of a 50% determining portion 114a, an 80% determining portion 114b and a 100% determining portion 114c that are set in a stepwise manner, while the contact surface 113 is contacted to a reference surface set on the inner face of each shoe.

As a result, it is possible to perform wear limit determination that can be judged at a glance with a simple structure without requiring a measurement work necessary for a vernier caliper measuring instrument.

It should be noted that the gauge for performing the wear inspection of the single component is obviously applicable not only to the bushing illustrated in FIG. 7 but also to the other components (link and shoe).

(B)

The aforementioned exemplary embodiment has been explained by exemplifying the wear limit determining portions that are set in three stages of 50%, 80% and 100% with respect to the wear loss limit (predetermined amount). However, the present invention is not limited to the above.

For example, the determining portions may not be set in the aforementioned stages as long as the stages are set in a plurality of stages including a stage of 100% with respect to the wear loss limit. The determining portions may be set in three stages of 80%, 90% and 100%, three stages of 60%, 80% and 100%, three stages of 50%, 75% and 100%, two stages of 80% and 100%, or four or more stages.

(C)

The aforementioned exemplary embodiment has been explained by exemplifying the main body 10a, 100a of the wear limit determining gauge 10, 100, which is made of a metal material such as a gauge steel plate or a stainless steel plate. However, the present invention is not limited to the above.

For example, the main body 10a, 100a may be made of another material such as resin.

Further, processing of a thin plate-shaped main body or injection molding with a die may be employed as a method of forming the respective contact surfaces and the respective determining parts on the circumference of the main body.

(D)

The aforementioned exemplary embodiment has been explained by exemplifying the present wear limit determining gauge 10 to be used for performing inspections of worn components in the periphery of the crawler belt 7a of the bulldozer 1. However, the present invention is not limited to the above.

For example, the present wear limit determining gauge may be also similarly used in performing a wear inspection of a track-related component of a tracked vehicle such as a hydraulic excavator except for a bulldozer.

### INDUSTRIAL APPLICABILITY

The wear limit determining gauge of the present invention can achieve an advantageous effect of quickly determining whether or not the wear loss of a worn component exceeds a predetermined amount with a simple structure. Therefore, the wear limit determining gauge is widely applicable as an inspection instrument for checking the replacement timing of a worn component.

1. A wear limit determining gauge to be used in determining whether a wear loss of a track-related component of a tracked vehicle exceeds a predetermined amount, comprising:
a main body formed in a plate shape;
a reference surface serving as a reference when determining a wear loss of a component;
a contact surface located on an end of the main body, the contact surface making contact the reference surface; and
a wear limit determining part including:
a first determining portion indicating that the wear loss is approximately equal to a first threshold amount, the first threshold amount being less than a predetermined amount;
a second determining portion including a first step disposed adjacent to the first determining portion, the second determining portion indicating that the wear loss is approximately equal to a second threshold amount, the second threshold amount being greater than the first threshold value and less than to the predetermined amount; and
a third determining portion including a second step disposed adjacent to the second determining portion, the third determining portion indicating that the wear loss is greater than or equal to the predetermined amount;
wherein the wear limit determining part is disposed on a worn side of the component when the contact surface is in contact with the reference surface.

2. The wear limit determining gauge recited in claim 1, further including:
a plurality of pairs, each pair including a contact surface and a wear limit determining part; and
a plurality of measurement target portions, the measurement target portions being various sizes;
wherein the pairs determine wear loss of the measurement target portions.

3. The wear limit determining gauge recited in claim 2, wherein:
the pairs of are disposed on a plurality of lateral surfaces of the main body.

4. The wear limit determining gauge recited in claim 2, wherein:
the contact surface is provided as a common contact surface corresponding to the plurality of wear limit determining parts.

5. The wear limit determining gauge recited in claim 1, wherein:
the track-related component includes a drive unit, the drive unit including a crawler link, a crawler bushing, and a crawler shoe.

6. The wear limit determining gauge recited in claim 5, wherein:
the wear limit determining part further include a first portion, a second portion, and a third portion,
the second portion is configured to determine a wear limit of the crawler bushing, and is disposed on a lateral surface of the main body,
the third portion is configured to determine a wear limit of the crawler shoe and is disposed on an opposite lateral surface of the main body respective to the second portion, and
the first portion is configured to determine a wear limit of the crawler link, and is disposed on a side of the main body that is different from the sides on which the second and third portions are disposed.

7. The wear limit determining gauge recited in claim 6, wherein:
the first portion and the second portion are disposed on the same lateral surface of the main body part and
the first portion and the second portion use the contact surface, in common, in order to determine the wear limits of the crawler link and crawler bushing.

8. A wear limit determining gauge to be used in determining whether or not a wear loss of each of track-related components of a tracked vehicle exceeds a predetermined amount, comprising:
a main body being formed in a plate shape;
a first reference surface serving as a reference when determining a wear loss of a first component;
a first contact surface located on an end of the main body, the first contact surface making contact with the first reference surface;
a first wear limit determining part disposed on a worn side of the first component when the first contact surface contacts the reference surface, the first wear limit determining part including:
a first determining portion indicating that the wear loss is approximately equal to a first threshold amount, the first threshold amount being less than a first predetermined amount;
a second determining portion including a step disposed adjacent to the first determining portion, the second determining portion indicating that the wear loss is approximately equal to a second threshold amount, the second threshold amount being greater than the first threshold amount and less than the first predetermined amount; and
a third determining portion including a step disposed adjacent to the second determining portion, the third determining portion indicating that the wear loss is greater than or equal to the first predetermined amount;
a second reference surface serving as a reference when determining the wear loss of a second component;
a second contact surface located on a different end of the main body from the end on which the first contact surface is located, the second contact surface making contact with the second reference surface;
a second wear limit determining part disposed on a worn side of the second component when the second contact surface contacts the reference surface, the second wear limit determining part including:
a fourth determining portion indicating that the wear loss is approximately equal to a fourth threshold amount, the fourth threshold amount being less than a second predetermined amount;
a fifth determining portion including a step disposed adjacent to the fourth determining portion, the fifth determining portion indicating that the wear loss is approximately equal to a fifth threshold amount, the fifth threshold amount being greater than the fourth threshold amount and less than the second predetermined amount; and
a sixth determining portion including a step disposed adjacent to the fifth determining portion, the sixth determining portion indicating that the wear loss is greater than or equal to the second predetermined amount;
a third reference surface serving as a reference when determining a wear loss of a third component;
a third contact surface located on a different end of the main body from the ends on which the first and second contact surfaces are disposed, the third contact surface making contact with the third reference surface; and
a third wear limit determining part disposed on a worn side of the third component when the third contact surface contacts the reference surface, the third wear limit determining part including:
a seventh determining portion indicating that the wear loss is approximately equal to a seventh threshold amount, the seventh threshold amount being less than a third predetermined amount;
an eighth determining portion including a step disposed adjacent to the seventh determining portion, the eighth determining portion indicating that the wear loss is approximately equal to an eighth threshold amount, the eighth threshold amount being greater than the seventh threshold amount and less than the third predetermined amount; and
a ninth determining portion including a step disposed adjacent to the eighth determining portion, the ninth determining portion indicating that the wear loss is greater than or equal to the third predetermined amount.
